(19) United States
(12) Patent Application Publication
(10) Pub. No.: US 2018/0047503 A1
(43) Pub. Date: Feb. 15, 2018

(54) IGNITION DEVICE

(71) Applicant: SANKEN ELECTRIC CO., LTD., Niiza-Shi (JP)

(72) Inventors: Kenichi SHIMIZU, Tokyo (JP); Toshio HAYASHIBARA, Shiki-shi (JP)

(73) Assignee: SANKEN ELECTRIC CO., LTD., Niiza-Shi (JP)

(21) Appl. No.: 15/671,427

(22) Filed: Aug. 8, 2017

(30) Foreign Application Priority Data
Aug. 9, 2016 (JP) 2016-156221
Jul. 11, 2017 (JP) 2017-135149

(51) Int. Cl. H01F 38/12; F02P 15/00; F02P 17/12; F02P 3/045

(52) U.S. Cl. CPC H01F 38/12; F02P 3/0453; F02P 15/005; F02P 17/12; H01F 30/12

(57) ABSTRACT

An ignition transformer includes a primary winding and a secondary winding and are electromagnetically coupled to each other. A battery is connected to a first end of the primary winding. A switch connected to a second end of the primary winding is turned on or off in response to an ignition signal. A saturable reactor includes a saturable core and includes a first winding, and a second winding the first and second windings electromagnetically coupled to each other. A first end of the first winding is connected to a first end of the second winding. A second end of the first winding is connected to the ignition plug. A reset circuit applies a reset voltage to the first and second ends of the second winding. The reset voltage is a voltage to switch a magnetization status of the saturable core between a saturated state and an unsaturated state.

### CROSS REFERENCE TO RELATED APPLICATIONS

This application claims priority based on 35 USC 119 from prior Japanese Patent Applications Nos. 2016-156221 filed on Aug. 9, 2016, and 2017-135149 filed on Jul. 11, 2017, entitled “IGNITION DEVICE”, the entire contents of which are herein incorporated by reference.

### BACKGROUND

The disclosure relates to an ignition device that causes a plug to ignite with a high voltage generated on a secondary ignition coil when a current in a primary ignition coil is intermittently interrupted.

An ignition device disclosed in Japanese Patent Application Publication No. H05-248334 has been known as an ignition device. FIG. 4 illustrates the internal-combustion engine ignition device described in Japanese Patent Application Publication No. H05-248334.

In FIG. 4, primary winding P1 and secondary winding S1 of ignition transformer T1 wind in opposite directions and perform flyback operation. Igniter control circuit 11 turns off igniter switch Q1 in response to an inputted ignition signal. Then, a current flowing from battery BT through primary winding P1 to igniter switch Q1 is interrupted. At this time, interruption of the current flowing through primary winding P1 induces a high voltage between both ends of secondary winding S1. The high voltage generated across secondary winding S1 causes plug 12 to ignite to thus drive the internal-combustion engine.

In addition, FIG. 5 illustrates another example of an ignition device of a related art. The ignition device in FIG. 5 is for driving a multicylinder engine (illustrated is a four-cylinder engine) and is provided with plugs 12-1 to 12-4 the number of which corresponds to the number of cylinders. A secondary side of ignition transformer T2 is provided with four secondary windings S2a to S2d. Switches SW1 to SW4 and plugs 12-1 to 12-4 are connected to corresponding secondary windings S2a to S2d. Each of switches SW1 to SW4 includes a semiconductor element such as a MOSFET. The switches SW1 to SW4 are turned on or off by rotation in order to cause plugs 12-1 to 12-4 to ignite one after another with time lags.

However, the ignition devices in FIGS. 4 and 5 has a risk that, since the high voltages generated on secondary windings S1 and S2a to S2d are applied to diode D1 and switches SW1 to SW4, those semiconductor elements may be broken. Consequently, the conventional ignition devices have to use semiconductor elements having high breakdown voltage, and this increases the cost.

### SUMMARY

One or more embodiments provide an ignition device that causes an ignition plug to ignite that comprises an ignition transformer that includes a primary winding and a secondary winding that are electromagnetically coupled to each other, a battery connected to a first end of the primary winding, a switch that is connected to a second end of the primary winding and is turned on or off in response to an ignition signal, a saturable reactor that includes a saturable core and includes a first winding with first and second ends, and a second winding with a first and second ends, the first and second windings electromagnetically coupled to each other, the first end of the first winding connected to the first end of the second winding, the second end of the first winding connected to the ignition plug, and a reset circuit that applies a reset voltage to the first and second ends of the second winding, the reset voltage being a voltage to switch a magnetization status of the saturable core between a saturated state and an unsaturated state.

One or more embodiments provide an ignition device that causes ignition plugs to ignite that comprises an ignition transformer that includes a primary winding with a first and second ends and a secondary winding with first and second ends, the primary and secondary windings electromagnetically coupled to each other, a battery connected to the first end of the primary winding, a switch that is connected to the second end of the primary winding and is turned on or off in response to an ignition signal, saturable reactors, the number of which corresponds to the number of the ignition plugs, the saturable reactors each including a saturable core and including a first winding with a first and a second ends and a second winding with a first and a second ends, the first and second windings electromagnetically coupled to each other, the first end of the first winding connected to the first end of the second winding, the second end of the first winding connected to the ignition plug, and reset circuits, the number of which corresponds to the number of the saturable reactors, the reset circuits each applying a reset voltage to the first and second ends of the second winding, the reset voltage being a voltage to switch a magnetization status of the saturable core between a saturated state and an unsaturated state.

### BRIEF DESCRIPTION OF DRAWINGS

FIG. 1 is a diagram illustrating a circuit configuration of an ignition device according to Example 1 of the present invention;

FIG. 2 is a diagram illustrating a circuit configuration of an ignition device according to Example 2 of the present invention;

FIG. 3 is a timing chart of four reset signals for resetting four saturable reactors, which are provided corresponding to four cylinders in the ignition device according to Example 2 of the present invention;

FIG. 4 is a diagram illustrating an example of a conventional ignition device; and

FIG. 5 is a diagram illustrating another example of a conventional ignition device.

### DETAILED DESCRIPTION

Embodiments are explained with referring to drawings. In the respective drawings referenced herein, the same constituents are designated by the same reference numerals and duplicate explanation concerning the same constituents may be omitted. All of the drawings are provided to illustrate the respective examples only. No dimensional proportions in the drawings shall impose a restriction on the embodiments. For this reason, specific dimensions and the like should be interpreted with the following descriptions taken into consideration. In addition, the drawings include parts whose dimensional relationship and ratios are different from one drawing to another.

### EXAMPLE 1

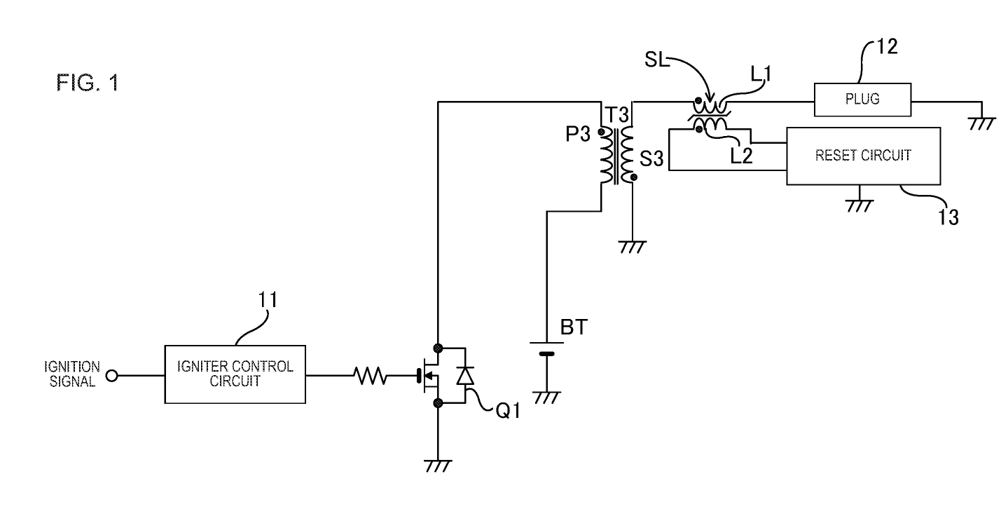

FIG. 1 is a diagram illustrating a circuit configuration of an ignition device according to Example 1 of the present invention. The ignition device of Example 1 in FIG. 1 differs from a conventional ignition device in FIG. 4 in a configuration of a secondary side of ignition transformer T3. Now the configuration of this part is thus described.

Ignition transformer T3 has primary winding P3 and secondary winding S3 that are electromagnetically coupled to each other.

In saturable reactor SL, first winding L1 and second winding L2 are wound on an un-illustrated saturable core including magnetic material and are electromagnetically coupled to each other. One end of first winding L1 is connected to one end of secondary winding S3, and the other end of first winding L1 is connected to one end of plug 12. The other end of plug 12 is grounded. Both ends of second winding L2 are connected to reset circuit 13. Saturable reactor SL uses a voltage applied from reset circuit 13 to second winding L2 in order to switch a magnetization status of the saturable core to a saturated state or an unsaturated state. In the saturated state, the saturable core is not magnetized; thus, the inductance of primary winding L1 is significantly decreased. In the unsaturated state, the saturable core is magnetized; thus, the inductance of primary winding L1 is significantly increased.

In reset circuit 13, a reset voltage for resetting the magnetization of the saturable core is applied to second winding L2. Once the reset voltage is applied to second winding L2, the saturable core is magnetized. This means that the magnetization of the saturable core is reset. Once the magnetization of the saturable core is reset, the magnetization status of the saturable core is changed into an unsaturated area. This significantly increases the inductance of primary winding L1.

Next, operations of the ignition device according to Example 1, which is formed as the above, are described. First, igniter control circuit 11 turns off igniter switch Q1 with an inputted ignition signal. Then, a current flowing from battery BT through primary winding P3 of ignition transformer T3 to igniter switch Q1 is interrupted.

At this time, a high voltage is applied to one side of primary winding P3 where its winding begins (marked with a filled circle), whereby a high voltage is generated on one side of secondary winding S3 where its winding begins (marked with a filled circle). In this case, when the high voltage pulse generated in secondary winding S3 of ignition transformer T3 is applied to saturable reactor SL, since the magnetization status of the saturable core is now the unsaturated area, the inductance of primary winding L1 is very high. Hence, no current flows through primary winding L1, and thus saturable reactor SL is changed into a switched-off state.

Thereafter, the high voltage pulse causes the magnetization status of the saturable core to be a saturated area, and the inductance of primary winding L1 is rapidly decreased. Hence, the current flows through primary winding L1, and thus saturable reactor SL is changed into a switched-on state. Applying the high voltage generated in secondary winding S3 to plug 12 causes plug 12 to ignite. The ignition of plug 12 may include at least one of firing and sparking.

Next, igniter control circuit 11 turns on igniter switch Q1 with an inputted ignition signal. This makes the high voltage pulse of ignition transformer T3 be turned off, and the polarity of the high voltage pulse inverts. While the polarity of the high voltage pulse is inverting, the reset voltage from reset circuit 13 resets the magnetization of the saturable core. In other words, since the reset voltage changes the magnetization status of the saturable core into the unsaturated area, and thus the inductance of primary winding L1 is very high, no current flows through primary winding L1, whereby the switch of saturable reactor SL is turned off.

In this way, saturable reactor SL operates as a switch circuit that turns on or off the high voltage generated on secondary winding S3 in order to apply the high voltage to plug 12 to cause plug 12 to ignite.

In addition, because saturable reactor SL includes the saturable core, which is made of the magnetic material, and first winding L1 and second winding L2, it is very rare that saturable reactor SL is broken by the high voltage generated on secondary winding S3. Hence, this ignition device has the high voltage resistance and can reduce the cost.

### EXAMPLE 2

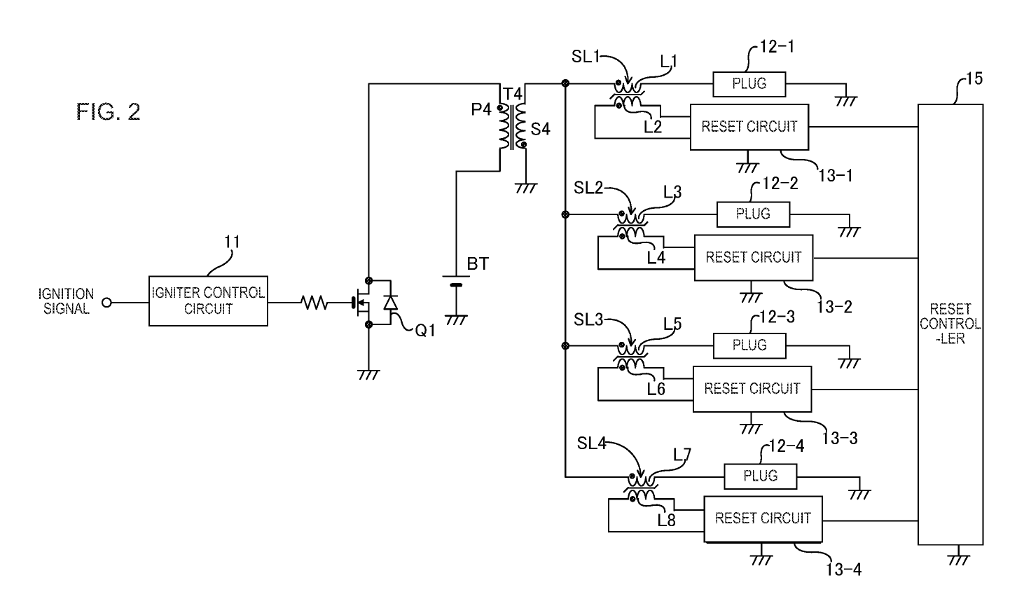

FIG. 2 is a diagram illustrating a circuit configuration of an ignition device according to Example 2 of the present invention. The ignition device according to Example 1 in FIG. 1 includes one plug; however, the ignition device according to Example 2 has a characteristic that the ignition device is provided with four plugs 12-1 to 12-4 corresponding to a four-cylinder engine. The operation for making each plug be ignited is the same as that in Example 1. In Example 2, reset signals RS1 to RS4 from reset controller 15 cause four plugs 12-1 to 12-4 to ignite by rotation.

Four saturable reactors SL1 to SL4 are provided corresponding to four plugs 12-1 to 12-4. On a saturable core of saturable reactor SL1, first winding L1 and second winding L2 are wound and electromagnetically coupled to each other. On a saturable core of saturable reactor SL2, first winding L3 and second winding L4 are wound and electromagnetically coupled to each other. On a saturable core of saturable reactor SL3, first winding L5 and second winding L6 are wound and electromagnetically coupled to each other. On a saturable core of saturable reactor SL4, first winding L7 and second winding L8 are wound and electromagnetically coupled to each other.

One end of first winding L1 is connected to one end of secondary winding S4, and the other end of first winding L1 is connected to one end of plug 12-1. The other end of plug 12-1 is grounded.

One end of first winding L3 is connected to one end of secondary winding S4, and the other end of first winding L3 is connected to one end of plug 12-2. The other end of plug 12-2 is grounded.

One end of first winding L5 is connected to one end of secondary winding S4, and the other end of first winding L5 is connected to one end of plug 12-3. The other end of plug 12-3 is grounded.

One end of first winding L7 is connected to one end of secondary winding S4, and the other end of first winding L7 is connected to one end of plug 12-4. The other end of plug 12-4 is grounded.

Four reset circuits 13-1 to 13-4 are provided corresponding to four saturable reactors SL1 to SL4. Reset circuit 13-1 applies a reset voltage on both ends of second winding L2. Reset circuit 13-2 applies a reset voltage on both ends of second winding L4. Reset circuit 13-3 applies a reset voltage on both ends of second winding L6. Reset circuit 13-4 applies a reset voltage on both ends of second winding L8.

Reset controller 15 controls driving of each of four reset circuits 13-1 to 13-4 by rotation.

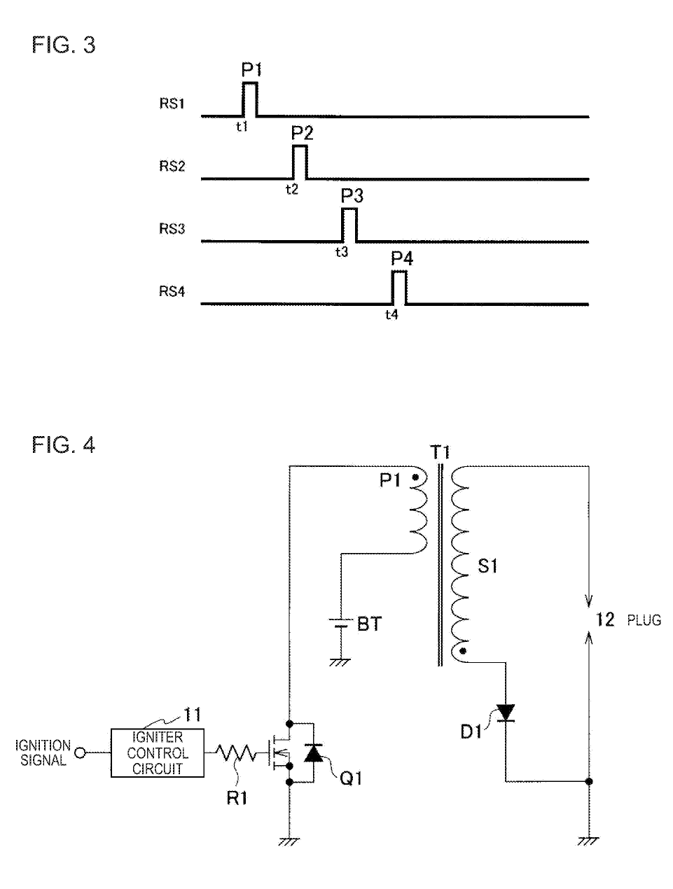

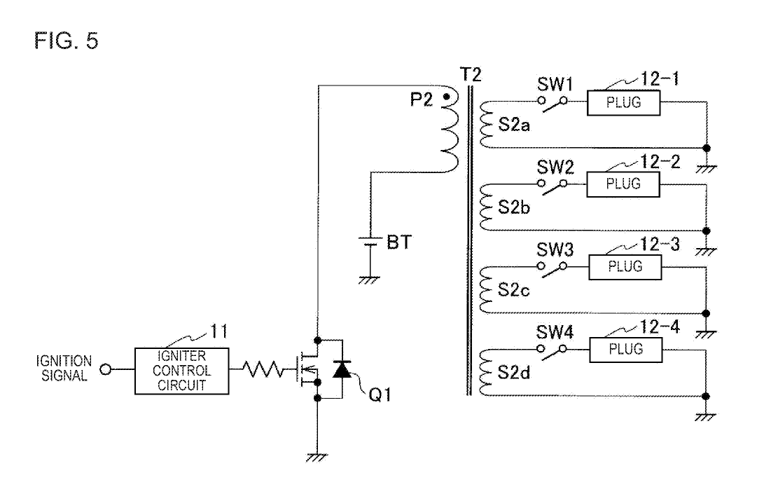

Next, operations of the ignition device according to Example 2, which is formed as the above, are described with reference to a timing chart of the reset signals illustrated in FIG. 3.

First, igniter control circuit 11 turns off igniter switch Q1 with an inputted ignition signal. Then, a current flowing from battery BT through primary winding P4 of ignition transformer T4 to igniter switch Q1 is interrupted.

This causes a high voltage pulse generated on second winding S4 of ignition transformer T4 to be applied to one ends of primary windings L1, L3, L5 and L7 of saturable reactors SL1 to SL4.

At time t1, reset controller 15 transmits reset pulse RS1 to reset circuit 13-1, and thus reset circuit 13-1 supplies the reset voltage to secondary winding L2 of saturable reactor SL1. The magnetization status of the saturable core of saturable reactor SL1 is now the unsaturated area, and the inductance of primary winding L1 is very high. Hence, the switch of saturable reactor SL1 is turned off.

Thereafter, the high voltage pulse changes the magnetization status of the saturable core of saturable reactor SL1 into the saturated area, and thus the inductance of primary winding L1 is rapidly decreased. Hence, the switch of saturable reactor SL1 is turned on, and thus plug 12-1 is ignited.

Next, at time t2, reset controller 15 transmits reset pulse RS2 to reset circuit 13-2, and thus reset circuit 13-2 supplies the reset voltage to saturable reactor SL2. The magnetization status of the saturable core of saturable reactor SL2 is now the unsaturated area, and the inductance is very high. Hence, the switch of saturable reactor SL2 is turned off.

Thereafter, the high voltage pulse changes the magnetization status of the saturable core of saturable reactor SL2 into the saturated area, and thus the inductance is rapidly decreased. Hence, the switch of saturable reactor SL2 is turned on, and thus plug 12-2 is ignited.

Next, at time t3, reset controller 15 transmits reset pulse RS3 to reset circuit 13-3, and thus reset circuit 13-3 supplies the reset voltage to saturable reactor SL3. The magnetization status of the saturable core of saturable reactor SL3 is now the unsaturated area, and the inductance is very high. Hence, the switch of saturable reactor SL3 is turned off.

Thereafter, the high voltage pulse changes the magnetization status of the saturable core of saturable reactor SL3 into the saturated area, and thus the inductance is rapidly decreased. Hence, the switch of saturable reactor SL3 is turned on, and thus plug 12-3 is ignited.

Next, at time t4, reset controller 15 transmits reset pulse RS4 to reset circuit 13-4, and thus reset circuit 13-4 supplies the reset voltage to saturable reactor SL4. The magnetization status of the saturable core of saturable reactor SL4 is now the unsaturated area, and the inductance is very high. Hence, the switch of saturable reactor SL4 is turned off.

Thereafter, the high voltage pulse changes the magnetization status of the saturable core of saturable reactor SL4 into the saturated area, and thus the inductance is rapidly decreased. Hence, the switch of saturable reactor SL4 is turned on, and thus plug 12-4 is ignited.

In this way, the ignition device according to Example 2 enables plugs 12-1 to 12-4 to be ignited by rotation with time lags.

In addition, since saturable reactors SL1 to SL4 includes the saturable core, which is made of the magnetic material, and first windings L1, L3, L5 and L7 and second windings L2, L4, L6 and L8, it is very rare that saturable reactors SL1 to SL4 are broken by the high voltage generated on secondary winding S4. Hence, this ignition device has the high voltage resistance and can reduce the cost.

According to one or more embodiments, once a high voltage pulse generated on a secondary winding of an ignition transformer is applied to a saturable reactor, a magnetization status of a saturable core is changed into an unsaturated area, and the inductance is very high. Hence, a switch of the saturable reactor is turned off. Thereafter, the high voltage pulse changes the magnetization status of the saturable core into a saturated area, and thus the inductance is rapidly decreased. Hence, the switch of the saturable reactor is turned on, and thus a plug is ignited. While the polarity of the high voltage pulse is inverting after the high voltage pulse of the transformer is turned off, applying the reset voltage from reset circuit resets the magnetization of the saturable core.

With using the saturable reactor in such a way, the ignition device according to one or more embodiments have the high voltage resistance and can reduce the cost.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. An ignition device that causes an ignition plug to ignite, comprising:
an ignition transformer that includes a primary winding and a secondary winding that are electromagnetically coupled to each other;
a battery connected to a first end of the primary winding;
a switch that is connected to a second end of the primary winding and is turned on or off in response to an ignition signal;
a saturable reactor comprising:
a saturable core;
a first winding including first and second ends; and
a second winding including a first and second ends, wherein
the first and second windings electromagnetically coupled to each other, the first end of the first winding connected to the first end of the second winding, the second end of the first winding connected to the ignition plug; and
a reset circuit that applies a reset voltage to the first and second ends of the second winding, the reset voltage being a voltage to switch a magnetization status of the saturable core between a saturated state and an unsaturated state.

2. An ignition device that causes ignition plugs to ignite, comprising:
an ignition transformer that includes a primary winding including a first and second ends and a secondary winding including first and second ends, the primary and secondary windings electromagnetically coupled to each other;
a battery connected to the first end of the primary winding;
a switch that is connected to the second end of the primary winding and is turned on or off in response to an ignition signal;
saturable reactors, the number of which corresponds to the number of the ignition plugs, the saturable reactors each comprising:
a saturable core;
a first winding including a first and a second ends; and
a second winding including a first and a second ends, wherein
the first and second windings electromagnetically coupled to each other, the first end of the first winding connected to the first end of the second winding, the second end of the first winding connected to the ignition plug; and
reset circuits, the number of which corresponds to the number of the saturable reactors, the reset circuits each applying a reset voltage to the first and second ends of the second winding, the reset voltage being a voltage to switch a magnetization status of the saturable core between a saturated state and an unsaturated state.

3. The ignition device according to claim 2, further comprising:
a reset controller that performs control to drive the reset circuits by rotation.
